(19) United States
(12) Patent Application Publication
(10) Pub. No.: US 2025/0333661 A1
(43) Pub. Date: Oct. 30, 2025

(54) SOLID BIOMASS FUEL ANTI-COKING ADDITIVE

(71) Applicant: Hong Mei Bai, Hong Kong (CN)

(72) Inventor: Hong Mei Bai, Hong Kong (CN)

(21) Appl. No.: 19/113,788

(22) PCT Filed: Sep. 20, 2023
(86) PCT No.: PCT/GB2023/052442

§ 371 Date: Mar. 20, 2025

(30) Foreign Application Priority Data
Sep. 20, 2022 (GB) 2213754.1

(51) Int. Cl. C10L 5/44; C10L 10/04

(52) U.S. Cl. CPC C10L 5/445; C10L 10/04; C10L 2200/0272; C10L 2230/08; C10L 2290/06; C10L 2290/08; C10L 2290/28; C10L 2290/32; C10L 2290/545

(57) ABSTRACT

A solid biomass fuel derived from one or more sources of biomass, wherein the one or more sources of biomass comprise: straw, palm-derived material, nut shells, hemp, bamboo, corn cob, rice husk, fruit shells, crop residues, seaweed, calliandra calothyrsus, acacia mangium, albizia chinensis, hevea brasiliensis, grass, or any combination thereof: wherein the solid biomass fuel further comprises one or more aluminosilicate-containing clays, one or more aluminosilicates, one or more pulverised fuel ashes, or a combination thereof.

### FIELD OF THE INVENTION

The present invention relates to the use of an additive for preventing or reducing coking during combustion of a solid biomass fuel, and a solid biomass fuel comprising said additive. Additionally, the present invention relates to a combustion process comprising combusting said solid biomass fuel comprising said additive so as to produce energy. The present invention also relates to processes for preparing solid biomass fuel comprising said additive.

### BACKGROUND OF THE INVENTION

Coal-fired power generation is used in power plants and industrial processes around the world. Coal and other fossil fuels are non-renewable energy resources. Over the last few decades, there have been calls to reduce the consumption of coal in coal-fired power stations and instead to use renewable resources for energy.

Fuels derived from biomass are an example of a renewable energy source that can be used to replace or at least partially replace coal. Biomass derived fuels can be burned in the presence of oxygen in power plants in combustion processes to produce energy. Biomass derived fuels can be combusted in traditional power plants originally designed for coal combustion, or biomass derived fuels can be combusted in power plants built specifically for biomass combustion. Certain forms of biomass can be mixed with coal and combusted in the same combustion process within a power plant. Such a process is known as coal co-firing of biomass. To be suitable for co-firing with coal, biomass derived fuel must typically have certain properties such as a certain level of quality and homogeneity with regard to properties. For example, biomass fuel comprised of particles of a homogenous size, density, moisture content etc. are particularly desirable in co-firing processes. It is also desirable that the biomass fuel contains a low level of ash. Levels of ash in biomass derived fuels are typically higher than those found in coal.

Various processes for producing solid biomass fuels from biomass sources are known. WO2016/056608, WO2017/175733 and WO2019/069849 disclose processes for forming solid biomass fuels from various wood-like sources of biomass. However, it is known by those of skill in the art that the solid biomass fuels and processes for their production discussed in these documents have various problems associated with them. For example, the wood-like biomass sources described in the above documents typically only occur naturally and are not easy to cultivate and harvest on a commercial scale. Additionally, the wood-like sources of biomass described in these documents, when subjected to conventional pulverising techniques, form particles with a low degree of homogeneity, meaning that solid biomass fuels produced from said materials are not sufficiently uniform. In light of these problems, there is a need in the art for a process for producing high performance solid biomass fuels from alternative sources of biomass (i.e. non-woody biomass sources). Particular solutions to these problems are disclosed in WO2020/229824, WO2021/014151, WO2021/024001 and WO2021/156628 which seek to ameliorate the problems discussed above. Despite the solutions proposed in the above-mentioned documents, there remains a need in the art for high performance solid biomass fuels.

A particular problem associated with solid biomass fuels is that on combustion of the fuels, deposition of ash often occurs in the combustion chamber and conduits in communication with the combustion chamber such as conduits used for emission of flue gas. Ash is the incombustible inorganic mineral component of solid biomass fuel that remains after complete combustion of the fuel. Ash typically contains a large amount of incombustible alkali metal salts (in particular, potassium). Alkali metal salts such as potassium chloride, sulphate and hydroxide are often found in the ash combustion by-product. These mineral salts typically have relatively low melting points. For example, the melting point of potassium chloride is only 770° C. Temperatures encountered in biomass combustion often exceed these temperatures causing the inorganic mineral salts to melt. The molten salts can cause problems during combustion since on cooling they can become sticky and stick to various internal surfaces of the combustion chamber and conduits in connection therewith. This process is known as slagging. The salts can also form fine aerosol particles that are emitted as an undesirable pollutant in flue gases. Gaseous alkali metal compounds such as potassium chloride, hydroxide and sulphate may also condense upon and undesirably react with the metal surface of conduits in fluid communication with the combustion chamber. These processes can ultimately cause fouling of the combustion apparatus. Ash associated combustion problems are typically more of a problem with solid biomass fuels than conventional coal since biomass typically contains a higher level of inorganic salts and metal ions than coal.

A different problem associated with the combustion of solid biomass fuels is the phenomenon known as coking that occurs upon combustion of the fuels. Coking is the formation of organic combustible deposits in the combustion chamber and in conduits or chambers in fluid communication therewith during combustion of the solid biomass fuel. Coking is the result of incomplete combustion of the fuel. Deposits that may form in coking include soot. Soot comprises particles of amorphous carbon and heavy hydrocarbons such as polyaromatic hydrocarbons (PAH). Soot often forms as a solid deposit in combustion chambers and flue gas chimneys. Soot can thus clog the combustion apparatus leading to operational problems. Soot particles may also be emitted in flue gases which is highly undesirable due to their greenhouse gas effects. Soot can also be carcinogenic. It is thus desirable for soot formation to be minimised. Other deposits that may form in coking include tar which is a viscous liquid comprising carbon and heavier hydrocarbons such as asphaltenes. Tar also deposits during coking in a similar way to soot as discussed above and causes similar problems. Deposited coke such as tar and soot may also combust at the temperatures found in combustion chambers and associated conduits in a process known as secondary combustion. Such a process forms undesirable polluting gaseous combustion products in the flue gas. The coking properties of a solid biomass fuel are distinct from and unrelated to the tendency of a biomass fuel to exhibit ash related problems upon combustion. Ash related problems and coking are different phenomena that arise due to different factors and that propagate via different mechanisms.

The factors that determine whether a fuel exhibits high amounts of coking on combustion are varied and complex. Coking may be caused by incomplete combustion of the solid biomass fuel. Factors such as the temperature of combustion and how much oxygen is successfully admixed with the fuel during combustion affect the extent of coking. Typically, lower combustion temperatures and lower air to fuel ratios cause more coking and promote incomplete combustion. The composition of the fuel in question also strongly affects the extent of coking and soot formation. Coking and formation of soot and tar proceed by complex chemical mechanisms that are not fully understood and may vary considerably between different fuels with different chemical compositions. For example, in the case of fossil fuels, naphthalenes tend to form more soot than benzenes which form more soot than aliphatic fuels. The coking properties of coal and solid biomass fuels are different due to the different chemical nature of the fuels. For example, in fossils fuels such as coal, the vast majority of the fuels are hydrocarbons (e.g. aromatics, alkanes, alkenes etc.). In fuels derived from biomass, there are a greater number of compounds comprising heteroatoms such as oxygenate compounds. This is due to the abundance of compounds containing such heteroatoms in nature. For example, a major portion of certain forms of biomass are the polymers cellulose and lignin. Cellulose is a polysaccharide and so contains a great number of oxygen atoms. Lignin also contains a great number of oxygen atoms. Fuels produced from biomass thus typically contain a higher amount of oxygen-containing compounds than fossil fuels. These chemical differences cause differences in the coking properties of the fuels. The coking properties of different solid biomass fuels such as those derived from different types of biomass source may also vary widely due to the different chemical nature of different types of biomass (for example differences in the amount of lignin and cellulose present in different types of biomass).

There remains a need in the art for methods of reducing coking during combustion of solid biomass fuels. In particular, there remains a need in the art for additives that can effectively reduce coking in solid biomass fuels derived from a variety of different biomass sources.

### SUMMARY OF THE INVENTION

The present invention is based on the surprising finding that certain additives, when incorporated into solid biomass fuels, can improve the coking properties of the solid fuels. It has surprisingly been found by the inventors that additives comprising one or more aluminosilicate-containing clays, one or more aluminosilicates, one or more pulverised fuel ashes, or a combination thereof can improve the coking properties of solid biomass fuels when incorporated therein. It is previously unknown and a surprising finding by the present inventors that said additives can improve the coke characteristics of solid biomass fuels when incorporated into said fuels. It has surprisingly been found that the additives discussed above reduce the tendency of solid biomass fuels to deposit coke (i.e. solid and/or liquid combustible organic material deposits) on the surfaces of combustion chambers and conduits in connection therewith when combusted. Additionally, it has been advantageously found that the additives suppress the secondary combustion of coke deposits once formed meaning that emission of harmful polluting gaseous secondary combustion products of the coke is reduced.

Surprisingly, it has been found that the additives discussed above can improve the coke properties of solid biomass fuels derived from a variety of different types of biomass. This is surprising in view of the chemical differences between solid fuels derived from different types of biomass.

However, it has been found that the use of the additives discussed above as anti-coking additives is particularly effective with certain types of non-woody biomass (as opposed to woody types of biomass sources such as those taught in WO2016/056608, WO2017/175733 and WO2019/069849). Without being limited by theory, this is believed to be due to certain non-woody types of biomass being able to be ground and pulverised more effectively by conventional techniques known in the art leading to pulverised biomass particles with a smaller particle size distribution (as discussed in detail in e.g. WO2020/229824, WO2021/014151, WO2021/024001 and WO2021/156628). It has been found that the smaller particle size distribution of the pulverised biomass allows the anti-coking additives discussed above to be incorporated in the solid biomass fuels in a more uniform manner. This has surprisingly been found by the inventors to improve the coke characteristics of the solid biomass fuels to a greater extent when compared to biomass fuels that form larger particle size distributions when pulverised such as solid fuels derived from wood-like sources of biomass.

According to a first aspect of the invention, there is provided a solid biomass fuel derived from one or more sources of biomass, wherein the one or more sources of biomass comprise: straw, palm-derived material, nut shells, hemp, bamboo, corn cob, rice husk, fruit shells, crop residues, seaweed, calliandra calothyrsus, acacia mangium, albizia chinensis, hevea brasiliensis, grass, or any combination thereof; wherein the solid biomass fuel further comprises one or more aluminosilicate-containing clays, one or more aluminosilicates, one or more pulverised fuel ashes, or a combination thereof.

The solid biomass fuel has improved coking properties when compared to an analogous solid biomass fuel that is identical to the fuel of the invention with the exception that it does not comprise one or more aluminosilicate-containing clays, one or more aluminosilicates, one or more pulverised fuel ashes, or a combination thereof.

Preferably, the one or more sources of biomass comprise straw, palm-derived material, nut shells, hemp, bamboo, corn cob, rice husk, fruit shells, crop residues, seaweed, calliandra calothyrsus, acacia mangium, albizia chinensis, hevea brasiliensis, grass, or any combination thereof, in an amount of at least 50% by weight; preferably at least 75% by weight; and more preferably at least 90% by weight.

More preferably, the one or more sources of biomass consist essentially of straw, palm-derived material, nut shells, hemp, bamboo, corn cob, rice husk, fruit shells, crop residues, seaweed, calliandra calothyrsus, acacia mangium, albizia chinensis, hevea brasiliensis, grass, or any combination thereof.

In some instances, the one or more sources of biomass comprises or consists essentially of straw; wherein the straw is selected from rice straw, tobacco straw, sesame straw, pepper straw, aubergine straw, cotton straw, sorghum straw, sunflower stalks, wheat stalks, corn stalks, rape stalks, tapioca straw, bean stalks, or any combination thereof.

In some instances, the one or more sources of biomass comprise or consist essentially of palm-derived material; wherein the palm derived material is selected from palm trunks, palm leaves, palm empty fruit bunches (EFB), Palm Kernel Shell (PKS), palm oil residue, palm husks, palm shell, palm fiber, or any combination thereof.

In some instances, the one or more sources of biomass comprise or consist essentially of nut shells; wherein the nut shells are selected from cashew shells, peanut shells, chestnut shells, pistachio shells, sunflower seed shells, walnut shells, pine cone shells, or any combination thereof.

In some instances, the one or more sources of biomass comprise or consist essentially of hemp; wherein the hemp is selected from ramie, jute, green hemp, flax, robin, hibiscus, or any combination thereof.

In some instances, the one or more sources of biomass comprise or consist essentially of bamboo; wherein the bamboo is selected from moso bamboo, hemp bamboo, arrow bamboo, or any combination thereof.

In some instances, the one or more sources of biomass comprise or consist essentially of fruit shells; wherein the fruit shells are selected from coconut shells, lychee shells, cinnamon (longan) shells, snake skin fruit shells, mangosteen shells, durian shells, or any combination thereof.

In some instances, the one or more sources of biomass comprise or consist essentially of crop residues; wherein the crop residues are selected from wheat husk, bagasse, okara, peanut residue, cassava residue, sweet potato residue, coffee bean residue, or any combination thereof.

In some instances, the one or more sources of biomass comprise or consist essentially of grass; wherein the grass is selected from a plant of the Penisetum genus, such as Penisetum sinese Roxb.

Typically, material derived from the one or more sources of biomass is present in the solid biomass fuel in an amount of at least 80% by weight. Preferably, material derived from the one or more sources of biomass is present in the solid biomass fuel in an amount of at least 90% by weight. More preferably, material derived from the one or more sources of biomass is present in the solid biomass fuel in an amount of at least 95% by weight.

Typically, where the solid biomass fuels comprise one or more aluminosilicate-containing clays, the one or more aluminosilicate-containing clays comprise kaolin.

Typically, where the solid biomass fuels comprise one or more aluminosilicates, the one or more aluminosilicates comprise one or more aluminosilicate minerals; one or more zeolites; one or more feldspars; one or more aluminosilicate glasses; or any combination thereof.

The one or more aluminosilicate minerals may comprise any suitable mineral such as andalusite, kyanite, sillimanite, or a combination thereof.

The one or more aluminosilicate glasses may comprise any suitable aluminosilicate glass such as alkali metal or alkali earth metal aluminosilicate glasses.

Typically, the total amount of the one or more aluminosilicate-containing clays, one or more aluminosilicates, one or more pulverised fuel ashes, or a combination thereof present in the solid biomass fuel is from 0.1% to 10% by weight of the solid biomass fuel; such as from 0.1% to 5% by weight of the solid biomass fuel. Preferably, the total amount of the one or more aluminosilicate-containing clays, one or more aluminosilicates, one or more pulverised fuel ashes, or a combination thereof present in the solid biomass fuel is from 0.1% to 1% by weight of the solid biomass fuel. More preferably, the total amount of the one or more aluminosilicate-containing clays, one or more aluminosilicates, one or more pulverised fuel ashes, or a combination thereof present in the solid biomass fuel is from 0.1% to 0.8% by weight of the solid biomass fuel; and most preferably from 0.5% to 0.8% by weight of the solid biomass fuel.

Preferably, the solid biomass fuel comprises one or more aluminosilicate-containing clays in a total amount of from 0.3% to 0.5% by weight of the solid biomass fuel; one or more aluminosilicates in a total amount of from 0.1% to 0.2% by weight of the solid biomass fuel; and one or more pulverised fuel ashes in an amount of from 0.1% to 0.2% by weight of the solid biomass fuel. Preferably, the one or more aluminosilicate-containing clays comprise kaolin.

Preferably, the one or more aluminosilicate-containing clays, one or more aluminosilicates, one or more pulverised fuel ashes, or a combination thereof are uniformly dispersed within the solid biomass fuel with the material derived from biomass.

Typically, the bulk density of the solid biomass fuel as determined according to DIN EN 15103 is from 0.50 kg/l to 0.8 kg/l, preferably from 0.60 kg/l to 0.75 kg/l, and more preferably from 0.60 to 0.70 kg/L.

Typically, the mechanical durability of the solid biomass fuel as determined according to DIN EN 15210-1 is 97% or more.

Typically, (i) the total dry sulphur content of the biomass solid fuel is 0.5 wt % or less, preferably 0.45 wt % or less, and most preferably 0.40 wt % or less, wherein the total dry sulphur content is determined according to DIN EN 15289.

Typically, (ii) the total dry hydrogen content of the biomass solid fuel is 3 wt % or more, preferably from 5 wt % to 10 wt %, and more preferably from 5 wt % to 7 wt %, wherein the total dry hydrogen content is determined according to DIN EN 15104.

Typically, (iii) the total dry oxygen content of the biomass solid fuel is 20 wt % or more, preferably from 25 wt % to 42 wt %, more preferably from 28 wt % to 40 wt %, wherein the total dry oxygen content is determined according to DIN EN 15296.

Typically, (iv) the total dry carbon content of the biomass solid fuel is 40 wt % or more, preferably from 45 wt % to 65 wt %, and more preferably from 50 wt % to 60 wt %, wherein total dry carbon content is determined according to DIN EN 15104.

Typically, (v) the total dry nitrogen content of the biomass solid fuel is less than 5.0 wt %, preferably less than 3.0 wt % and more preferably less than 2.5 wt %, wherein the total dry nitrogen content is determined according to DIN EN 15104.

The solid biomass fuel may typically be as defined in any one or more of options (i) to (v) recited above. Preferably, the solid biomass fuel is as defined in any three or more of options (i) to (v) recited above. More preferably, the solid biomass fuel is as defined in all of options (i) to (v) recited above.

Typically, (vi) the chemical oxygen demand (COD) of the solid biomass fuel when immersed in water is 5000 ppm or less, preferably 4000 ppm or less, and most preferably 3200 ppm or less, wherein the chemical oxygen demand is determined according to GB/11914-89.

Typically, (vii) the fixed carbon content of the solid biomass fuel is 20 wt % or more, preferably from 25 wt % to 45 wt %, wherein the fixed carbon content is determined according to DIN EN 51734.

Typically, (viii) the ash content of the solid biomass fuel is less than 20 wt %, preferably less than 18 wt %, wherein the ash content is determined according to EN 14775 at 550° C.

Typically, (ix) the volatile matter content of the solid biomass fuel is from 35 wt % to 80 wt %, more preferably from 40 wt % to 75 wt %, wherein the volatile matter content is determined according to DIN EN 15148.

Typically, (x) the internal moisture content of the solid biomass fuel is less than 8 wt %, preferably less than 6 wt %, and more preferably less than 5 wt %, wherein the internal moisture content is determined according to DIN EN 14774.

The solid biomass fuel may typically be as defined in any one or more of options (vi) to (x) recited above. Preferably, the solid biomass fuel is as defined in any three or more of options (vi) to (x) recited above. More preferably, the solid biomass fuel is as defined in all of options (vi) to (x) recited above.

Typically, the biomass solid fuel has a calorific value of from 4300 kcal/kg to 6750 kcal/kg, wherein the calorific value is determined in accordance with DIN EN 14918.

Typically, the biomass solid fuel has a base moisture content of less than 10 wt %, preferably less than 8 wt %, and most preferably less than 6 wt %, wherein the base moisture content is determined according to GB/T211-2017.

Typically, the pH of the solid biomass fuel is from 4 to 10.

Typically, the solid biomass fuel is waterproof for up to 20 days, preferably up to 30 days, and more preferably up to 40 days.

Typically, the PM1.0 emissions of the solid biomass fuel upon combustion is less than 175 mg/kg, preferably less than 150 mg/kg.

Typically, the coke characteristics of the solid biomass fuel upon combustion is less than or equal to 1.5; and preferably from 0.3 to 1.5, wherein the coke characteristics are determined according to GB/T8727-2008.

Typically, the solid biomass fuel is obtained or obtainable by a process according to the fourth aspect of the invention, as is discussed in further detail below.

According to a second aspect of the invention, there is provided a process for combusting a solid biomass fuel according to the first aspect of the invention.

Typically, the solid biomass fuel is co-fired and combusted alongside a fossil fuel such as coal.

Typically, the PM1.0 emissions of the process are less than 175 mg/kg, and preferably less than 150 mg/kg.

According to a third aspect of the invention, there is provided the use of one or more aluminosilicate-containing clays, one or more aluminosilicates, one or more pulverised fuel ashes, or a combination thereof in a solid biomass fuel as an anti-coking additive.

Preferably, the use comprises using the anti-coking additive to reduce or prevent the formation of solid and/or liquid combustible organic material deposits during combustion of the solid biomass fuel. More preferably, the solid and/or liquid combustible organic material deposits are deposited on surfaces of a combustion chamber used in combustion of the solid biomass fuel, and/or conduits in fluid communication therewith.

Preferably, the use comprises using the anti-coking additive to prevent or reduce secondary combustion of the solid and/or liquid combustible organic material deposits.

Typically, the solid and/or liquid combustible organic material comprises soot, tar, or a combination thereof.

Typically, the solid biomass fuel is derived from one or more sources of biomass; wherein the one or more sources of biomass comprise straw, palm-derived material, nut shells, hemp, bamboo, corn cob, rice husk, fruit shells, residues, seaweed, calliandra calothyrsus, acacia mangium, albizia chinensis, hevea brasiliensis, grass, or any combination thereof.

Preferably, the solid biomass fuel, sources of biomass, one or more aluminosilicate-containing clays, one or more aluminosilicates and/or one or more pulverised fuel ashes are as described above in the context of the first aspect of the invention.

According to a fourth aspect of the invention, there is provided a process for producing a solid biomass fuel according to the first aspect of the invention, wherein the process comprises the following steps:
(i) providing a biomass composition comprising biomass particles with an average particle diameter (D50) of from 1,000 μm to 75,000 μm;
(ii) pulverising the biomass composition to provide a pulverised biomass powder with an average particle diameter (D50) of from 500 μm to 10,000 μm;
(iii) drying the pulverised biomass powder so as to provide a dried pulverised biomass powder;
(iv) molding the dried pulverised biomass powder so as to provide a molded biomass product; wherein the dried pulverised biomass powder is molded with one or more aluminosilicate-containing clays, one or more aluminosilicates, one or more pulverised fuel ashes, or a combination thereof so as to provide the molded biomass product;
(v) heating the molded biomass product to a temperature of from 110° C. to 500° C. for a time period of from 0.2 to 6 hours so as to provide a solid biomass fuel; and
(vi) removing dust particles from the solid biomass fuel.

Typically, the biomass composition comprises one or more sources of biomass comprising straw, palm-derived material, nut shells, hemp, bamboo, corn cob, rice husk, fruit shells, crop residues, seaweed, calliandra calothyrsus, acacia mangium, albizia chinensis, hevea brasiliensis, grass, or any combination thereof. Preferably, the one or more sources of biomass are as described above in the context of the first aspect of the invention.

Preferably, the solid biomass fuel, sources of biomass, one or more aluminosilicate-containing clays, one or more aluminosilicates and/or one or more pulverised fuel ashes are as described above in the context of the first aspect of the invention.

Typically, adapting the molding step such that the density of the molded biomass product is controlled comprises controlling the compression ratio of a mold used in said molding step. Typically, step (iv) of molding the dried pulverised biomass powder so as to provide a molded biomass product comprises molding the dried pulverised biomass powder with a compression mold with a compression ratio of less than 6; such as less than 5. Preferably, step (iv) of molding the dried pulverised biomass powder so as to provide a molded biomass product comprises molding the pulverised biomass powder with a compression mold with a compression ratio of less than or equal to 3.5; more preferably less than or equal to 3; and most preferably from 1 to 3.

Typically, the one or more aluminosilicate-containing clays, one or more aluminosilicates, one or more pulverised fuel ashes, or a combination thereof and dried pulverised biomass powder are molded together in a mass ratio so as to provide a solid biomass fuel comprising a total amount of the one or more aluminosilicate-containing clays, one or more aluminosilicates, one or more pulverised fuel ashes, or a combination thereof of from 0.1% to 10% by weight of the solid biomass fuel; preferably from 0.1% to 5% by weight of the solid biomass fuel; more preferably from 0.1% to 1% by weight of the solid biomass fuel; still more preferably from 0.1% to 0.8% by weight of the solid biomass fuel; and most preferably from 0.5% to 0.8% by weight of the solid biomass fuel.

In one highly preferable instance, the one or more aluminosilicate-containing clays, one or more aluminosilicates, one or more pulverised fuel ashes, or a combination thereof and dried pulverised biomass powder are molded together in a mass ratio so as to provide a solid biomass fuel comprising the one or more aluminosilicate-containing clays in an amount of from 0.3% to 0.5% by weight of the solid biomass fuel; the one or more aluminosilicates in a total amount of from 0.1% to 0.2% by weight of the solid biomass fuel; and the one or more pulverised fuel ashes in an amount of from 0.1% to 0.2% by weight of the solid biomass fuel.

### BRIEF DESCRIPTION OF THE DRAWINGS

FIG. 1 is a photograph of an apparatus known in the art that can be used for chipping one or more sources of biomass.

FIG. 2 is a diagram of a typical compression mold that may be used in accordance with the invention, showing the compression ratio used in the molding step.

FIG. 3 shows the coke characteristics of various biomass fuels of the invention, as determined by GB/T212-2008.

FIG. 4 shows the coke characteristics of various comparative biomass fuels that do not comprise anti-coking additives, as determined by GB/T212-2008.

### DETAILED DESCRIPTION OF THE INVENTION

### Sources of Biomass

Any sources of plant-derived biomass may be used in the present invention. Preferably, the one or more sources of biomass from which the solid biomass fuels are derived are as discussed above.

It is preferred that the one or more sources of biomass comprise non-woody sources of biomass. As discussed above, it has surprisingly been found that the additives for use in the present invention are more effective at imparting anti-coking properties to solid biomass fuels derived from non-woody biomass sources. This is believed to be as the additives can be incorporated more uniformly into the solid biomass fuels than into fuels derived from woody biomass sources. Surprisingly, this has been found to provide a greater improvement in coking characteristics of the solid biomass fuels. In other words, whilst the anti-coking additives for use in the invention can still be effective when used with woody sources of biomass, the improvement in coke properties of the fuels on incorporation of the additives therein is less when compared to the improvement when the fuels are derived from non-woody biomass sources.

The terms “wood”, “woody biomass”, or “wood-like biomass” as used herein, are typically used to refer to the hard fibrous substance consisting basically of xylem that makes up the greater part of the stems, branches, and roots of trees or shrubs beneath the bark. Wood is only found to a limited extent in herbaceous plants. This definition of the term “wood” is in line with the commonly understood definition in the art.

Preferably, the one or more sources of biomass from which the solid biomass fuels are derived comprise less than 50% by weight of woody biomass; more preferably les than 20% by weight; and most preferably less than 10% by weight.

Preferably, as discussed above, the one or more sources of biomass comprise: straw, palm-derived material, nut shells, hemp, bamboo, corn cob, rice husk, fruit shells, crop residues, seaweed, calliandra calothyrsus, acacia mangium, albizia chinensis, hevea brasiliensis, grass, or any combination thereof. Unlike wood-like sources of biomass, these sources of biomass can be grown and harvested on a commercial scale, providing increased control of the quality and specific characteristics of the biomass sources compared to the wood-like materials. Use of said biomass sources also avoids the environmental damage associated with using trees such as necessary deforestation. Use of these sources of biomass is also easier to grind than wood-like materials which reduces the costs of the grinding process. Use of these materials, when ground, also provides a more homogenous mix of particle sizes which provides a final solid biomass fuel product with improved uniformity.

More preferably, the one or more sources of biomass comprise rice straw, tobacco straw, pepper straw, aubergine straw, cassava straw, yellow bean straw, chick pea straw, glycine max straw, palm leaves, cashew shells, Chinese chestnut shells, pistachio shells, sunflower seed shells, walnut shells, pine nut shells, hemp, moso bamboo, hemp bamboo, arrow bamboo, lychee shells, cinnamon (logan) shells, snake skin fruit shells, mangosteen shells, durian shells, soybean residue, peanut residue, cassava residue, sweet potato residue, coffee bean residue, or combinations thereof. Still more preferably, the one or more sources of biomass comprise these materials in an amount of from 80% to 100% by weight. Most preferably, the one or more sources of biomass consist essentially of the abovementioned materials. The use of these materials is particularly preferred as it has surprisingly been found that these materials all provide solid biomass fuels with surprisingly high mechanical durabilities of over 97%. This can even be achieved whilst using a lower compression ratio of less than 3.6 when molding pellets of the solid biomass fuel. Typically, when using other sources of biomass, higher compression ratios are required to achieve solid fuels with high mechanical durabilities (as discussed in further detail below). The use of a lower compression ratio is preferred if possible since it provides a greater yield of biomass fuel when molding the fuel into pellets. A high mechanical durability of 97% or over for the solid biomass fuels is advantageous since fuels with high durability have been found to be able to be stored outside without damage for periods as long as two months without being damaged by rainfall and other adverse weather conditions. High mechanical durability is also desirable since durable fuels are less likely to disintegrate and fall apart or form dust during processing, transport or storage.

The sources of biomass used in accordance with the invention may be produced as agricultural waste as a by-product of an agricultural operation. Alternatively, these sources of biomass may be grown specifically for the purpose of being a feedstock for the preparation of biomass solid fuels. Each of the one or more sources of biomass discussed above can be obtained or harvested by conventional methods known in the art. Many of the sources of biomass described above for use in accordance with the invention can be agricultural waste. The term “agricultural waste” as used herein typically refers to plant-based waste products that are produced as a by-product of agricultural operations. For example, agricultural waste may comprise left over plant-based products that are harvested, or unwanted components of harvested plant-based products.

The term “comprising” as used herein is used to mean that any further undefined component can be present. The term “consisting” as used herein is used to mean that no further components can be present, other than those specifically listed. The term “consisting essentially of” as used herein is used to mean that further undefined components may be present, but that those components do not materially affect the essential characteristics of the composition.

### Anti-Coking Additives

The solid biomass fuels of the present disclosure comprise at least one anti-coking additive. The at least one anti-coking additive may comprise one or more aluminosilicate-containing clays, one or more aluminosilicates, one or more pulverised fuel ashes, or a combination thereof.

Examples of aluminosilicate-containing clays that may be used include any of such clays known in the art. For example, clays that may be used include kaolin, montmorillonite clays and illite clays. Preferably, the clays comprise kaolin.

Examples of aluminosilicates that may be used include any of such materials known in the art. Specific examples of aluminosilicates that may be used include one or more aluminosilicate minerals; one or more zeolites; one or more feldspars; one or more aluminosilicate glasses; or any combination thereof.

The one or more aluminosilicate minerals may comprise any suitable mineral such as andalusite, kyanite, sillimanite, or a combination thereof.

The one or more aluminosilicate glasses may comprise any suitable aluminosilicate glass such as alkali metal or alkali earth metal aluminosilicate glasses.

The one or more pulverised fuel ashes may comprise any suitable known type of pulverised fuel ash. For example, fly ash produced from coal combustion may be used. The one or more pulverised fuel ashes typically comprise mixtures of silicon dioxide, aluminium oxide, and calcium oxide which are the main mineral compounds present in coal-bearing rock strata.

The solid biomass fuels of the disclosure may comprise any suitable amounts of the additives described above for achieving the anti-coking effect. Preferably, the anti-coking additives are present in the amounts described above. Surprisingly, it has been found that the anti-coking additives are effective when included in the solid biomass fuels in very low amounts (such as in an amount of less than 1% by weight of the solid biomass fuels). This is especially the case where the solid biomass fuels are derived from the non-woody types of biomass discussed above. Without being limited by theory, it is believed that this is due to the ability to more effectively uniformly disperse the additives in the solid biomass fuels where the fuels are derived from the preferred non-woody types of biomass, as discussed in greater detail above.

Accordingly, it is preferred that the one or more aluminosilicate-containing clays, one or more aluminosilicates, one or more pulverised fuel ashes, or a combination thereof are substantially uniformly dispersed within the solid biomass fuel with the material derived from biomass. More preferably, the one or more aluminosilicate-containing clays, one or more aluminosilicates, one or more pulverised fuel ashes, or a combination thereof are uniformly dispersed within the solid biomass fuel with the material derived from biomass. It has been found by the inventors that this uniform dispersion of the additive increases the anti-coking effect of the additives and the advantages discussed above.

In a highly preferable instance, the solid biomass fuel comprises one or more aluminosilicate-containing clays in a total amount of from 0.3% to 0.5% by weight of the solid biomass fuel; one or more aluminosilicates in a total amount of from 0.1% to 0.2% by weight of the solid biomass fuel; and one or more pulverised fuel ashes in an amount of from 0.1% to 0.2% by weight of the solid biomass fuel.

The term anti-coking additive as used herein refers to an additive that imparts an anti-coking effect to the solid biomass fuel upon combustion. The term anti-coking effect as used herein refers to the ability of the additive to reduce or eliminate the tendency of the solid biomass fuel to deposit coke when combusted. The term coke as used herein refers to a liquid or solid deposit comprising combustible organic material that is deposited on the surfaces of a combustion chamber or conduits and other chambers in communication therewith upon combustion of the solid biomass fuel. Preferably, the combustible organic material comprises carbon, hydrocarbons, hydrocarbon oxygenates, or any combination thereof. The deposit is preferably a solid. Solid coke may be referred to as soot and liquid coke may be referred to as tar. Coke deposits are distinct from ash deposits in that coke relates to combustible organic material formed from incomplete combustion of solid biomass fuel. In contrast, the term ash refers to the incombustible inorganic residue formed from complete combustion of solid biomass fuel. As discussed above, factors that affect ash related operational problems and coking when combusting solid biomass fuel are different. Coking upon combustion occurs via a different mechanism to ash related operational problems such as slag formation and slag fouling.

In addition to preventing the deposition of coke on internal surfaces of the combustion chamber and conduits and other chambers associated therewith, it has been found that the anti-coking additives discussed above also reduce the tendency of deposited coke to undergo secondary combustion and thus form gaseous polluting secondary combustion products that are typically formed and emitted in flue gases. This is a secondary effect in addition to the primary effect of reducing coke deposition. In other words, the formation of the secondary combustion products is reduced as the additives reduce the deposition of coke in the first place, but also because they reduce the tendency of deposited coke to undergo secondary combustion thus forming polluting gases

### The Solid Biomass Fuel

The solid biomass fuel product may have any of the physical properties discussed above.

The biomass solid fuel of the disclosure preferably comprises pellets. The pellets may be any suitable size. Preferably, the pellets have a diameter of from 3 mm to 100 mm, and more preferably, 5 mm to 8 mm. Preferably, the pellets have a length of from 20 mm to 60 mm, and more preferably from 30 mm to 50 mm.

Biomass fuels of the invention are sufficiently water proof up to 20 days, preferably 30 days and more preferably 40 days. The water proof properties of the solid biomass fuels may be determined according to standard tests of the Energy Research Centre of the Netherlands (ECN).

The moisture content of the biomass solid fuel of the disclosure may also be determined by standard ECN test methods. The internal moisture content of the solid biomass composition fuel of the invention is typically less than 8 wt %, preferably less than 6 wt %, and more preferably less than 5 wt %, wherein the internal moisture content is determined according to DIN EN 14774.

The biomass composition solid fuel has a base moisture content of typically less than 10 wt %, preferably less than 8 wt %, and most preferably less than 6 wt %, wherein the base moisture content is determined according to GB/T211-2017.

Typically, other than additives such as the anti-coking additives discussed above, no other fuel sources are included in the solid biomass fuels. Accordingly, the solid biomass fuel typically comprises only material derived from biomass as the fuel source in the solid biomass fuel. For example, when the heated biomass composition product is molded into pellets, typically, no other fuel source is added to the sources of biomass prior to molding such that the solid biomass fuel pellets only contain a fuel source derived from biomass.

Preferably, the solid biomass fuel thus comprises at least 50% by weight of the total fuel content of the fuel, such as at least 60% by weight, at least 70% by weight, at least 80% by weight, at least 90% by weight and preferably at least 95% by weight of material derived from biomass.

The solid biomass fuel preferably comprises material derived from biomass in an amount of at least 75% by weight; preferably at least 80% by weight and more preferably at least 90% by weight.

### Processes for Making the Solid Biomass Fuels

Preferably, the methods for the preparation of the solid biomass fuels involve methods where one or more sources of biomass are pulverised, molded and then torrefied; or pulverised, torrefied and then molded. The anti-coking additives are typically added during the step of molding the biomass. It is highly preferred that the anti-coking additives are effectively dispersed within the solid biomass fuel such that the additives are substantially uniformly dispersed within the fuel.

Preferably, the solid biomass fuels are obtained or obtainable by a process for producing a solid biomass fuel, wherein the process comprises the following steps:
(i) providing a biomass composition comprising biomass particles with an average particle diameter (D50) of from 1,000 μm to 75,000 μm;
(ii) pulverising the biomass composition to provide a pulverised biomass powder with an average particle diameter (D50) of from 500 μm to 10,000 μm;
(iii) drying the pulverised biomass powder so as to provide a dried pulverised biomass powder;
(iv) molding the dried pulverised biomass powder so as to provide a molded biomass product; wherein the dried pulverised biomass powder is molded with one or more aluminosilicate-containing clays, one or more aluminosilicates, one or more pulverised fuel ashes, or a combination thereof so as to provide the molded biomass product;
(v) heating the molded biomass product to a temperature of from 110° C. to 500° C. for a time period of from 0.2 to 6 hours so as to provide a solid biomass fuel; and
(vi) removing dust particles from the solid biomass fuel.

Further discussion of each of these steps is included below.

### Providing the Biomass Composition

The process may comprise step (i) of providing a biomass composition comprising biomass particles with an average particle diameter (D50) of from 1,000 μm to 75,000 μm. Preferably, the biomass composition comprises biomass particles with an average particle diameter (D50) of from 1,000 μm to 60,000 μm. For example, in some instances, the biomass composition comprises biomass particles with an average particle diameter (D50) of from 30,000 μm to 60,000 μm such as an average particle diameter of from 40,000 μm to 50,000 μm.

The biomass composition may be provided as particles with a size in the above range by introducing one or more sources of biomass into a conventional chipping apparatus, although this will of course be dependent upon the specific source of biomass. For example, if the source of biomass occurs naturally with particles having sizes in the above range, then chipping will not be necessary. Accordingly, the process of the invention may comprise chopping one or more sources of biomass so as to provide a biomass composition comprising biomass particles having an average particle diameter (D50) of from 1,000 μm to 75,000 μm, or any of the other size ranges described above.

The step of providing the biomass composition with an average particle diameter (D50) of from 1,000 μm to 75,000 μm may comprise harvesting the one or more sources of biomass with a conventional combine. The combining process involves chopping and breaking up the biomass into particles of the desired size.

The step of providing the biomass composition may additionally comprise reducing the water content of the biomass to less than 50% by weight. Such a step may comprise compressing the biomass composition. This compression step typically squeezes moisture from the biomass composition such that the moisture content of the biomass composition is reduced to less than 50% by weight. Accordingly, in some instances, the step of providing a biomass composition with a particle size as discussed above comprises compressing a biomass composition with a moisture content of more than 70% by weight such that after compression, the moisture content of the biomass composition is less than 50% by weight.

The step of providing a biomass composition with a particle size as discussed above may comprise both a step of compressing the biomass and also a step of chopping the biomass.

The chopping step and compression step (if included) may be carried out using separate apparatus. Alternatively, the steps may be carried out in a single apparatus configured for both chipping and compressing the biomass. For example, a motorised rolling device suitable for compressing biomass may be placed on a conveyor belt that feeds a conventional chipping device. In this respect, the biomass source is compressed before it enters the chipper. Apparatus suitable for carrying out compression and chipping steps of the one or more sources of biomass are known in the art.

An example of an apparatus used for chipping is shown in FIG. 1. Chipping apparatus such as those shown in FIG. 1 typically work on the principle of material entering the chipper via a conveying system such as conveyor belt that feeds material through a feeding port. The material is then cut into chips by a high-speed rotating blade (not shown) and a blade mounted on the base of the machine (not shown). The functioning of said mechanism and of similar chipping mechanisms are known to the person skilled in the art.

### Pulverisation of Biomass

Step (ii) may comprise pulverising the biomass composition to provide a pulverised biomass powder with an average particle diameter (D50) of from 500 μm to 10,000 μm.

The biomass composition may be pulverised into a biomass powder by standard techniques known in the art. The biomass composition may be pulverised such that the biomass powder has an average particle diameter (D50) of from 500 μm to 10,000 μm. Preferably, the biomass composition is pulverised to have an average particle diameter of from 1000 μm to 8,000 μm, and more preferably from 1,000 to 5000 μm. As discussed above, pulverising non-woody sources of biomass such as the specific biomass sources mentioned above has been found to provide a biomass powder with an advantageous smaller particle size distribution than provided by grinding prior known wood-like biomass sources.

It has further been found that the smaller the particle size distribution of pulverised biomass powder, the greater the quality and performance characteristics of the biomass solid fuel product. Without being limited by theory, this is believed to be due to greater uniformity and homogeneity of the final solid biomass fuel product. Smaller powder particle size and greater uniformity and homogeneity of the final fuel product is believed to be linked to improved performance characteristics of the fuel upon combustion, and also to improved water-proof characteristics of the solid fuel product.

As discussed above, greater uniformity also means that the anti-coking additives are more effectively and uniformly dispersed in the solid biomass fuels meaning that better anti-coking properties can be provided, and more effective anti-coking properties at lower concentration of the additive.

Prior to pulverisation, the biomass composition typically comprises less than 50% by weight of moisture.

Different pulverisation processes are preferred for different sources of biomass with different moisture contents. For example, when the moisture content of the biomass composition is 20% by weight or less, preferably, the step of pulverising the biomass involves the use of a negative pressure pneumatic conveyancing apparatus. Such negative pressure pneumatic conveyancing apparatus are known in the art.

When the moisture content of the biomass composition is 20% by weight or greater, the biomass composition may be directly pulverised without the use of a negative pressure pneumatic conveyancing apparatus.

The average particle diameter (D50) of the biomass particles discussed above in the context of steps (i) and (ii) of the disclosed process may be determined using techniques known in the art to the skilled person. For example, standard tests ISO 17827-1 and/or ISO 17827-2 may be used to calculate the D50 of the biomass particles.

### Drying the Pulverised Biomass Powder

The biomass may be dried in step (iii) of the process. Step (iii) of drying the pulverised biomass powder so as to provide a dried pulverised biomass powder typically comprises drying the pulverised biomass powder such that the dried pulverised biomass powder has a moisture content of from 10% by weight to 18% by weight, preferably from 12% by weight to 15% by weight. However, it will be appreciated that it is not essential that the dried pulverised biomass powder has a moisture content within this range.

The step of drying the biomass powder may also comprise mixing the pulverised biomass powder. If one source of biomass is used in the process, this single source of biomass may be mixed. Alternatively, if more than one source of biomass is used in the process, the drying step may involve mixing the pulverised biomass powder with one or more additional sources of biomass. For example, where the solid biomass fuels are formed from at least two sources of biomass, whilst the two or more sources of biomass can be mixed during any step of the process of the disclosure, preferably the sources of biomass are mixed during the drying step of the process of the disclosure. The pulverised biomass powder may thus be mixed with an additional source of biomass that is also a pulverised biomass powder prepared using the process steps described herein. Alternatively, the one or more additional sources of biomass mixed with the pulverised biomass powder during the drying step are not processed as described herein. For example, the pulverised biomass powder prepared as described herein may be mixed with one or more additional sources of biomass that are prepared in different ways.

The anti-coking additives may also be mixed with the biomass derived material at this stage of the process.

The pulverised biomass powder may be dried using any suitable method, such as using standard drying cylinders known in the art. For example, the drying step may be carried out in a drying apparatus that comprises a rotating drying drum. The rotation of the rotating drying drum can be used to mix the pulverised biomass powder with one or more additional sources of biomass as described above. Typically, the rotating drying drum comprises a lifting plate. The lifting plate continuously raises material while the drying cylinder rotates

Where the pulverised biomass powder has a moisture content of less than 20 wt %, typically, the pulverised biomass powder is dried in a single drying cylinder. Accordingly, in these instances, the process of the disclosure comprises drying the pulverised biomass powder in a only one single drying cylinder.

Where the pulverised biomass powder has a moisture content of greater than 20 wt %, the pulverised biomass powder is typically dried in multiple drying cylinders. Accordingly, in these instances, the process of the disclosure comprises drying the pulverised biomass powder in more than one drying cylinder. For example, the process may comprise drying the pulverised biomass powder in two or more, three or more, four or more, or five or more drying cylinders.

### Molding the Dried Pulverised Biomass Powder

The dried pulverised biomass powder may be molded so as to provide a molded biomass product. The molding step may be carried out in any molding apparatus known in the art and in accordance with biomass molding techniques known in the art, and may include extrusion systems. Preferably, the molding step is carried out in a compression mold. Preferably, the compression mold comprises a mold product exit hole. The molding step may be carried out using an apparatus as described in CN105435708.

Preferably, the molding step comprises molding the dried pulverised biomass powder into pellets. Accordingly, preferably, the molded biomass product and solid biomass fuel product comprises biomass pellets.

It has been found that adapting the molding step such that the density of the molded biomass product produced from said step is controlled so as to be within a certain range imparts certain advantageous properties to the final solid biomass fuel product. Specifically, controlling the molding step such that the density of the molded biomass product is within the range of from 1.0 to 1.35 kg/L has been found to impart advantageous properties to the final biomass fuel product. Preferably, the molding step is controlled such that the density of the molded biomass product is from 1.0 kg/L to 1.35 kg/L. Typically, the above mentioned densities are determined according to NY/T 1881.7-2010. Accordingly, preferably, the molding step is controlled such that the density of the molded biomass product is from 1.0 kg/L to 1.35 kg/L, wherein the density is determined according to NY/T 1881.7-2010.

The molding step may be controlled in a variety of ways. Where the molding process comprises the use of a compression mold, the density is typically controlled by using a compression ratio of less than 8, such as less than 7, less than 6, less than 5, or less than 4. Preferably, a compression ratio of less than or equal to 3.5 is used, more preferably less than or equal to 3, and most preferably from 1 to 3.

It has been found by the inventors that these compression ratios are preferred for molding pulverised biomass with the anti-coking additives for use in the invention.

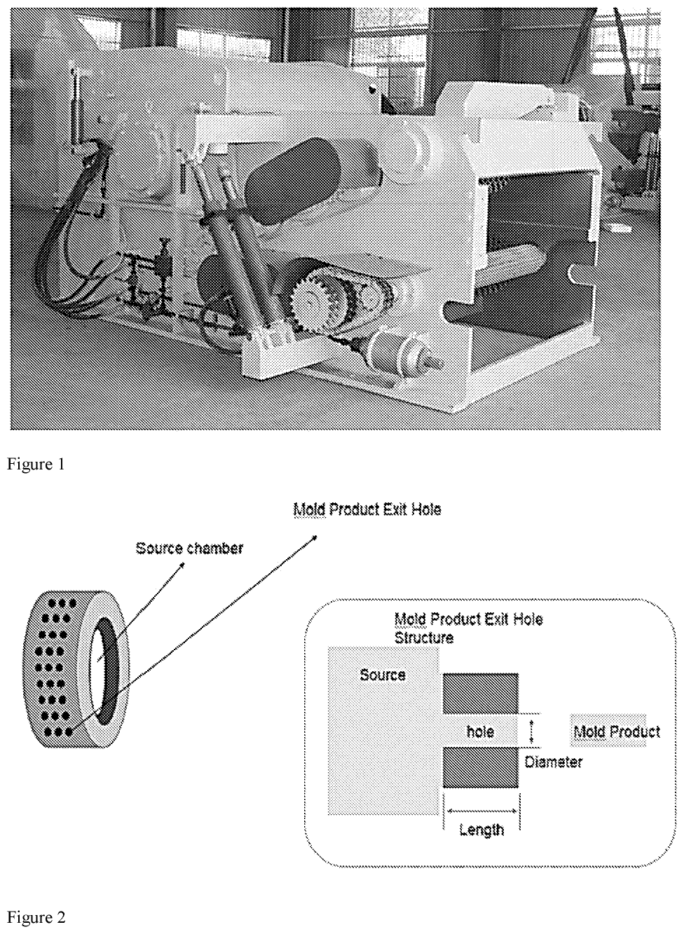

The compression ratio for a compression mold with a mold product exit hole may be defined as the ratio of the length to the diameter of the mold product exit hole. FIG. 2 shows an example of a compression mold that may be used in accordance with the present invention. The dried pulverised biomass powder is inserted into the interior of the mold before being squeezed from inside the mold by pressure such that it exits the mold product exit hole in the Figure. The compression ratio is shown in the Figure as the ratio of the length of the product out hole to its diameter.

Typically, the smaller the compression ratio, the lower the density of the molded biomass product. It is desirable for the density of the molded biomass product to be higher, such as within the abovementioned range, as this is believed by the inventors to be associated with high durability of the final solid biomass fuel product, along with increased bulk density, increased water-proof capacity and increased uniformity of the solid fuel product. Accordingly, higher compression ratios are often desirable in order to provide a final solid biomass fuel product with the desired properties. However, the higher the compression ratio, the lower the yield of the molded biomass product. Higher compression ratios also typically increase the costs of a process due to the higher pressures involved to mold the biomass. Accordingly, there is a balance to be struck between high enough compression ratios to provide desired fuel properties but without the ratio being too high that the process yield is reduced or process cost increased. It has been found that when the anti-coking additives of the present disclosure are included in solid biomass fuel compositions, the compression ratios discussed above are preferred to provide a balance between process yield and desirable solid fuel properties.

Preferably, a molding additive is added to the dried pulverised biomass powder prior to step (iv) of molding the dried pulverised biomass powder. Said additive is believed to improve the molding process and increase the yield of the molded biomass product produced from the molding step. Suitable molding additives are known in the art and include, but are not limited to starch, or starch derivatives.

Typically, other than molding additives such as those discussed above, no other fuel source is added to the dried pulverised biomass powder during the molding step. Accordingly, the molded biomass product of the molding step typically comprises only material derived from biomass as the fuel source in the solid biomass fuel. For example, when the dried pulverised biomass powder is molded into pellets, typically, no other fuel source is added to the dried pulverised biomass products prior to molding such that the solid biomass fuel pellets produced at the end of the process only contain a fuel source derived from biomass. Preferably, the solid biomass fuel thus comprises at least 50% by weight of the total fuel content of the fuel, such as at least 60% by weight, at least 70% by weight, at least 80% by weight, at least 90% by weight and preferably at least 95% by weight of material derived from biomass.

Where the term total fuel content of the solid fuel is used herein, this is intended to refer to the component of the solid fuel that is combustible material such as biomass derived material and coal. The term fuel content in relation to solid fuel is not intended to encompass additives that may be present in the solid fuel pellets that do not themselves combust to produce energy.

The molding step has also been found to enhance the waterproof properties of the final biomass solid fuel product. The increase in density that occurs during the molding step means that it is harder for water to penetrate the denser molded biomass product particles.

Furthermore, with a denser product, more biomass is concentrated in the interior of the molded product, and so is not in direct contact with water.

The one or more aluminosilicate-containing clays, one or more aluminosilicates, one or more pulverised fuel ashes, or a combination thereof and dried pulverised biomass powder are molded together in a mass ratio so as to provide a solid biomass fuel comprising a desired amount of the anti-coking additives.

As discussed above, the anti-coking additives are preferably be added to the biomass particles prior to molding and are mixed in with the biomass particles in as uniform manner as possible prior to molding.

### Heating the Molded Biomass Product

The molded biomass product may be heated so as to produce a solid biomass fuel. The heating is carried out at a temperature of from 110° C. to 500° C. for a time period of from 0.2 to 6 hours. Preferably, the step of heating the molded biomass product is carried out for a time period of from 0.3 to 2.5 hours. Preferably, the step of heating the molded biomass product comprises heating the molded biomass product to a temperature of from 220° C. to 350° C., and more preferably to a temperature of from 220° C. to 320° C.

Preferably, the step (v) of heating the molded biomass product comprises heating the molded biomass product under conditions so as to induce torrefaction of the molded biomass product. Torrefaction is a process of mild pyrolysis in which the heating is carried out in a low oxygen atmosphere such as an atmosphere of less than 10% oxygen content. Suitable conditions and processes of torrefaction are known in the art. Accordingly, preferably step (v) of heating the molded biomass product comprises torrefaction.

The heating step may be carried out in any suitable apparatus known in the art for heating the molded biomass product. For example, the heating step may be carried out in apparatus and using process conditions as disclosed in EP3287509A1.

Preferably, step (v) of heating the molded biomass product is adapted so as to control the uniformity of the solid biomass fuel, optionally wherein adapting step (v) so as to control the uniformity of the solid biomass fuel comprises conducting step (v) in an apparatus in which the molded biomass product is rotated whilst being heated, optionally, wherein adapting step (v) so as to control the uniformity of the solid biomass fuel comprises controlling the speed or direction of rotation of the molded biomass product, optionally wherein the molded biomass product is rotated in the apparatus in both an anticlockwise and clockwise direction. The uniformity of the solid biomass fuel is also optimised by the heating temperatures and time periods discussed above.

The process of the disclosure may comprise a step of cooling the solid biomass fuel after heating. Where the process of the disclosure comprises a cooling step after the step of heating the biomass, the cooling step may comprise rotating the solid biomass fuel. The biomass may be rotated in a suitable apparatus such as those disclosed in EP3287509A1. Preferably, both heating step (v) and the step of cooling the biomass comprise rotating the biomass. Where the biomass is rotated in either the cooling step or the heating step, the biomass may be rotated in different directions, such as both clockwise and anti-clockwise in successive cycles.

The term ‘uniformity’ of the solid biomass product is used to refer to the solid biomass fuel or molded biomass product having constant or similar properties across each particle of solid biomass fuel or molded biomass product and across the plurality of particles within a bulk sample of the solid biomass fuel product or molded biomass product. For example, but not limited to, the densities of the particles, the ease of combustion of the particles, the chemical composition of the particles, and the water resistant properties of the particles. Uniformity is a highly desirable property for biomass fuels for use in combustion processes.

It has also been found by the inventors that controlling the heating step in the manner discussed above additionally aids in providing a solid biomass fuel product with enhanced water proof properties. During the heating step, hydrophilic compounds present in the biomass powders that absorb water are degraded. Furthermore, the heating step causes oils present in the biomass powders to migrate to the exterior of the biomass powder particles, increasing the hydrophobicity of said particles.

Removing Dust Particles from the Solid Biomass Fuel

The process of the disclosure may comprise step of removing dust particles from the solid biomass fuel. It has been found by the inventors of the present invention that in biomass solid fuel production processes known in the art, significant quantities of dust adheres to the solid biomass fuel. This dust is problematic because it may pollute the air during transport and packaging of the solid biomass fuel. The dust may also pollute the local environment. Furthermore, when stored in the open air, dust particles form mildew and affect the performance and quality of the solid biomass fuel. Thus, it would be beneficial for dust on the surfaces of the particles of the solid biomass fuel to be removed.

The inventors have found that the dust on the surface of the biomass solid fuel particles may be removed by inducing friction between the particles. For example, dust that is adhered to the particles may be removed by inducing friction by means such as vibrating or rotating the solid biomass fuel particles. Accordingly, a step (vi) of removing dust from the solid biomass particles may comprise inducing friction between the particles of solid biomass fuel. For example, step (vi) of removing dust from the solid biomass particles may comprise subjecting the particles to vibration, rotation, rolling, or any combination thereof. Suitable apparatus for conducting rolling, rotation, and vibration of the solid biomass fuel particles are known to the person skilled in the art. An example of an apparatus that may be used to remove dust from the particles is a rotating drum sieve.

Step (vi) of removing dust particles from the solid biomass fuel may comprise removing dust particles from the solid biomass fuel with a screen. Typically, the screen has a pore size of from 2 mm to 10 mm, preferably 2 mm to 8 mm, more preferably from 2 mm to 5 mm, and most preferably from 2 mm to 3 mm. Dust particles that are admixed with the solid biomass fuel particles may be separated from the solid biomass fuel by passing through the screen. The larger solid biomass fuel particles do not pass through the screen and are thus separated from the dust particles. Suitable apparatus and methods for performing the screening step are known to those skilled in the art, and any of said suitable apparatus may be used. For example, an apparatus that employs screening, rolling and rotating the solid biomass fuel may be used to remove dust particles from the solid biomass fuel. In the use of such a device, solid biomass fuel may be laid upon a screen, and the screen may be driven to roll and rotate upon its axis by operation of a motor. During rolling/tilting and rotation of the screen, material on the sieve surface of the screen is turned over. Some material passes through the screen and is separated from material that does not pass through the screen. The rolling and rotation of the screen causes material stuck in the pores of the screen to fall through and thus clogging of the pores of the screen is prevented. Alternatively, an apparatus that vibrates and screens the solid biomass fuel particles may be used. In this case, a motor can be used to vibrate the screen which may cause material to be thrown up on the screen surface. This process may cause small particles adhered to larger ones to come loose and then pass through the pores in the screen. An example of an apparatus that employs a screen and vibration to separate larger particles from smaller particles, where the smaller particles may or may not be adhered to the larger particles is a device as taught in CN201324717.

Accordingly, methods of the disclosure may comprise subjecting the solid biomass fuel particles to one or more of rolling, rotation and vibration so as to induce friction between the solid biomass fuel particles which causes dust particles adhered to said solid biomass fuel particles to be removed from said particles. The methods then preferably comprise subjecting the mixture of solid biomass fuel particles and dust particles to a screening step as discussed above to remove said dust particles from said solid biomass fuel particles. Accordingly, removal step (vi) is an effective post-treatment for removing dust from said particles of solid biomass fuel.

### EXAMPLES

Various solid biomass fuels of the invention were produced using the process of the invention. The molding steps involved the use of a compression mold with a compression ratio of 3. The anti-coking additives were added to the biomass material prior to the molding step. Prior to the molding step, the biomass particles and anti-coking additives were mixed to form a uniform mixture which was then molded into pellets. The heating step involved heating the molded pellets to a temperature of 320° C. for a time period of 1.8 hours.

The anti-coking additives used were kaolin in an amount of 0.4% by weight of the solid biomass fuel; aluminosilicate in an amount of 0.1% by weight of the solid biomass fuel; and coal pulverised fuel ash in an amount of 0.1% by weight of the solid biomass fuel. The solid fuel products thus each comprised 0.6% by weight of anti-coking additives.

The biomass source materials used are detailed in Table 1 below.

TABLE 1

| Example | Source material |
|---|---|
| A | Tobacco straw |
| B | Palm leaves |
| C | Cashew shells |
| D | Hemp (flax) |
| E | Arrow bamboo |
| F | Rice husk |
| G | Corn cob |
| H | Lychee shells |
| I | Peanut residue |
| J | Seaweed |
| K | Calliandra calothyrsus |
| M | Palm leaves & Cashew shells |

The bulk densities of each solid biomass fuel were in the range of from 0.6 to 0.7 kg/L.

The mechanical durabilities of each solid biomass fuel were in the range of from 95% to 98%. The mechanical durability of each of fuels A to F, H and I was 97% or more.

The dry sulphur contents of each of the solid biomass fuels were in the range of from 0.02 wt % to 0.25 wt %.

The dry hydrogen contents of each of the solid fuels were in the range of from 5 wt % to 6 wt %.

The dry oxygen contents of each of the solid biomass fuels were in the range of from 30 wt % to 38 wt %.

The dry carbon contents of each of the solid biomass fuels were in the range of from 50 wt % to 58 wt %.

The dry nitrogen contents of each of the solid biomass fuels were in the range of from 0.5 wt % to 1.6 wt %.

The chemical oxygen demands of each of the solid biomass fuels were in the range of from 1100 to 2700.

The fixed carbon contents of each of the solid biomass fuels were from 27 wt % to 40 wt %.

The ash contents of each of the solid biomass fuels were in the range of from 4 wt % to 16 wt %.

The internal moisture contents of each of the solid biomass fuels were in the range of from 0.4 wt % to 2.8 wt %.

The volatile matter contents of each of the solid biomass fuels were in the range of from 48% to 67%.

The PM 1.0 emissions of each of the solid biomass fuels were in the range of from 129 to 145 mg/kg.

The calorific values of each of the solid biomass fuels were in the range of from 5000 to 6200 kcal/kg.

The received base moisture contents each of the solid biomass fuels were in the range of from 1.5% to 4.5%.

The pH of each of the solid biomass fuels were in the range of from 4.5 to 8.6.

The solid biomass fuels of Examples A to M thus have suitable high performance fuel properties such as high bulk density, mechanical durability, energy content and water proof capacity etc. The properties of the fuels are comparative to solid biomass fuels produced in prior art documents WO2020/229824, WO2021/014151, WO2021/024001 and WO2021/156628.

Comparative example compositions A to K were also produced using the same method as for the Example compositions. The only difference between example compositions A to K and comparative example compositions A to K were that the comparative example compositions did not comprise any anti-coking additive.

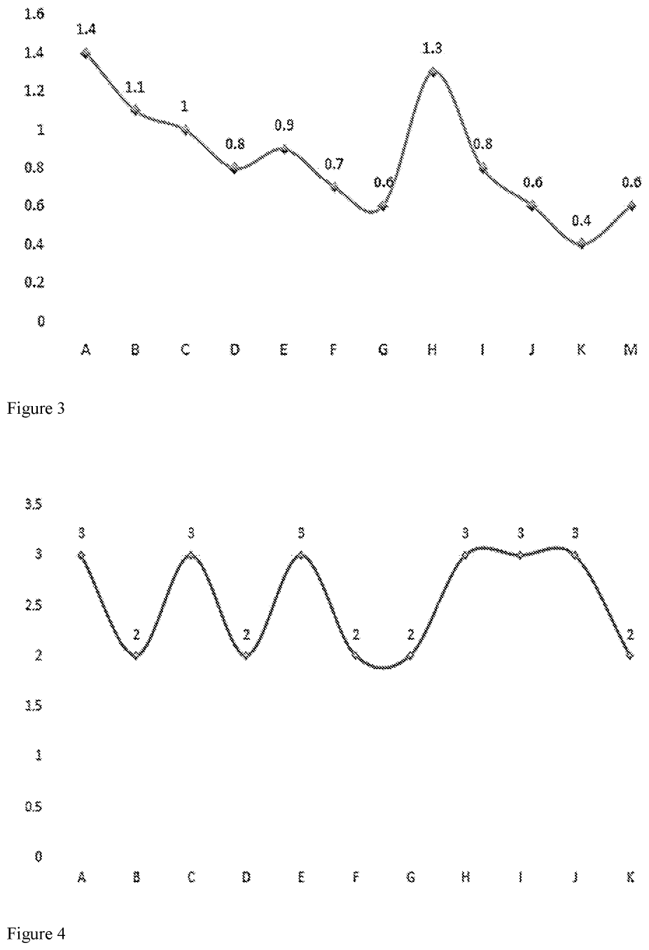

The coke characteristics of the solid biomass fuels produced in Examples A to M as determined according to GB/T8727-2008 are shown in FIG. 3. The coke characteristics of comparative example compositions A to K are shown in FIG. 4.

It can be seen that the example compositions of the invention each had a lower coke characteristics score than all of the comparative example compositions. This is indicative of the compositions of the invention producing less coke deposit upon combustion and less secondary combustion product emissions. The comparison of these figures thus demonstrates that the anti-coking additive for use in the invention effectively improves the coke characteristics of solid biomass fuels derived from a variety of different sources of biomass.

1. A solid biomass fuel derived from one or more sources of biomass, wherein the one or more sources of biomass comprise: straw, palm-derived material, nut shells, hemp, bamboo, corn cob, rice husk, fruit shells, crop residues, seaweed, calliandra calothyrsus, acacia mangium, albizia chinensis, hevea brasiliensis, grass, or any combination thereof; wherein the solid biomass fuel further comprises one or more aluminosilicate-containing clays, one or more aluminosilicates, one or more pulverised fuel ashes, or a combination thereof.

2. A solid biomass fuel according to claim 1, wherein the one or more sources of biomass comprise straw, palm-derived material, nut shells, hemp, bamboo, corn cob, rice husk, fruit shells, crop residues, seaweed, calliandra calothyrsus, acacia mangium, albizia chinensis, hevea brasiliensis, grass, or any combination thereof, in an amount of at least 50% by weight; preferably at least 75% by weight; and more preferably at least 90% by weight.

3. A solid biomass fuel according to claim 1 or claim 2, wherein the one or more sources of biomass consist essentially of straw, palm-derived material, nut shells, hemp, bamboo, corn cob, rice husk, fruit shells, crop residues, seaweed, calliandra calothyrsus, acacia mangium, albizia chinensis, hevea brasiliensis, grass, or any combination thereof.

4. A solid biomass fuel according to any preceding claim, wherein the one or more sources of biomass comprises or consists essentially of straw; wherein the straw is selected from rice straw, tobacco straw, sesame straw, pepper straw, aubergine straw, cotton straw, sorghum straw, sunflower stalks, wheat stalks, corn stalks, rape stalks, tapioca straw, bean stalks, or any combination thereof.

5. A solid biomass fuel according to any of claims 1 to 3, wherein the one or more sources of biomass comprise or consist essentially of palm-derived material; wherein the palm derived material is selected from palm trunks, palm leaves, palm empty fruit bunches (EFB), Palm Kernel Shell (PKS), palm oil residue, palm husks, palm shell, palm fiber, or any combination thereof.

6. A solid biomass fuel according to any of claims 1 to 3, wherein the one or more sources of biomass comprise or consist essentially of nut shells; wherein the nut shells are selected from cashew shells, peanut shells, chestnut shells, pistachio shells, sunflower seed shells, walnut shells, pine cone shells, or any combination thereof.

7. A solid biomass fuel according to any of claims 1 to 3, wherein the one or more sources of biomass comprise or consist essentially of hemp; wherein the hemp is selected from ramie, jute, green hemp, flax, robin, hibiscus, or any combination thereof.

8. A solid biomass fuel according to any of claims 1 to 3, wherein the one or more sources of biomass comprise or consist essentially of bamboo; wherein the bamboo is selected from moso bamboo, hemp bamboo, arrow bamboo, or any combination thereof.

9. A solid biomass fuel according to any of claims 1 to 3, wherein the one or more sources of biomass comprise or consist essentially of fruit shells; wherein the fruit shells are selected from coconut shells, lychee shells, cinnamon (longan) shells, snake skin fruit shells, mangosteen shells, durian shells, or any combination thereof.

10. A solid biomass fuel according to any of claims 1 to 3, wherein the one or more sources of biomass comprise or consist essentially of crop residues; wherein the crop residues are selected from wheat husk, bagasse, okara, peanut residue, cassava residue, sweet potato residue, coffee bean residue, or any combination thereof.

11. A solid biomass fuel according to any of claims 1 to 3, wherein the one or more sources of biomass comprise or consist essentially of grass; wherein the grass is selected from a plant of the Penisetum genus, such as Penisetum sinese Roxb.

12. A solid biomass fuel according to any preceding claim, wherein material derived from the one or more sources of biomass is present in the solid biomass fuel in an amount of at least 80% by weight.

13. A solid biomass fuel according to any preceding claim, wherein material derived from the one or more sources of biomass is present in the solid biomass fuel in an amount of at least 90% by weight.

14. A solid biomass fuel according to any preceding claim, wherein material derived from the one or more sources of biomass is present in the solid biomass fuel in an amount of at least 95% by weight.

15. A solid biomass fuel according to any preceding claim, wherein the one or more aluminosilicate-containing clays comprise kaolin.

16. A solid biomass fuel according to any preceding claim, wherein the one or more aluminosilicates comprise one or more aluminosilicate minerals; one or more zeolites; one or more feldspars; one or more aluminosilicate glasses; or any combination thereof.

17. A solid biomass fuel according to any preceding claim, wherein the total amount of the one or more aluminosilicate-containing clays, one or more aluminosilicates, one or more pulverised fuel ashes, or a combination thereof present in the solid biomass fuel is from 0.1% to 10% by weight of the solid biomass fuel; preferably from 0.1% to 5% by weight of the solid biomass fuel.

18. A solid biomass fuel according to any preceding claim, wherein the total amount of the one or more aluminosilicate-containing clays, one or more aluminosilicates, one or more pulverised fuel ashes, or a combination thereof present in the solid biomass fuel is from 0.1% to 1% by weight of the solid biomass fuel.

19. A solid biomass fuel according to any preceding claim, wherein the total amount of the one or more aluminosilicate-containing clays, one or more aluminosilicates, one or more pulverised fuel ashes, or a combination thereof present in the solid biomass fuel is from 0.1% to 0.8% by weight of the solid biomass fuel; preferably from 0.5% to 0.8% by weight of the solid biomass fuel.

20. A solid biomass fuel according to claim 19, wherein the solid biomass fuel comprises one or more aluminosilicate-containing clays in a total amount of from 0.3% to 0.5% by weight of the solid biomass fuel; one or more aluminosilicates in a total amount of from 0.1% to 0.2% by weight of the solid biomass fuel; and one or more pulverised fuel ashes in an amount of from 0.1% to 0.2% by weight of the solid biomass fuel.

21. A solid biomass fuel according to claim 20, wherein the one or more aluminosilicate-containing clays comprise kaolin.

22. A solid biomass fuel according to any preceding claim, wherein the one or more aluminosilicate-containing clays, one or more aluminosilicates, one or more pulverised fuel ashes, or a combination thereof are uniformly dispersed within the solid biomass fuel with the material derived from biomass.

23. A solid biomass fuel according to any preceding claim, wherein the bulk density of the solid biomass fuel as determined according to DIN EN 15103 is from 0.50 kg/l to 0.8 kg/l, preferably from 0.60 kg/l to 0.75 kg/l, and more preferably from 0.60 to 0.70 kg/L.

24. A solid biomass fuel according to any preceding claim, wherein the mechanical durability of the solid biomass fuel as determined according to DIN EN 15210-1 is 97% or more.

25. A solid biomass fuel according to any preceding claim, wherein (i) the total dry sulphur content of the solid biomass fuel is 0.5 wt % or less, preferably 0.45 wt % or less, and most preferably 0.40 wt % or less, wherein the total dry sulphur content is determined according to DIN EN 15289; (ii) the total dry hydrogen content of the biomass solid fuel is 3 wt % or more, preferably from 5 wt % to 10 wt %, and more preferably from 5 wt % to 7 wt %, wherein the total dry hydrogen content is determined according to DIN EN 15104; (iii) the total dry oxygen content of the biomass solid fuel is 20 wt % or more, preferably from 25 wt % to 42 wt %, more preferably from 28 wt % to 40 wt %, wherein the total dry oxygen content is determined according to DIN EN 15296; (iv) the total dry carbon content of the biomass solid fuel is 40 wt % or more, preferably from 45 wt % to 65 wt %, and more preferably from 50 wt % to 60 wt %, wherein total dry carbon content is determined according to DIN EN 15104; and/or (v) the total dry nitrogen content of the biomass solid fuel is less than 5.0 wt %, preferably less than 3.0 wt % and more preferably less than 2.5 wt %, wherein the total dry nitrogen content is determined according to DIN EN 15104.

26. A solid biomass fuel according to any preceding claim, wherein (i) the chemical oxygen demand (COD) of the solid biomass fuel when immersed in water is 5000 ppm or less, preferably 4000 ppm or less, and most preferably 3200 ppm or less, wherein the chemical oxygen demand is determined according to GB/11914-89; (ii) the fixed carbon content of the solid biomass fuel is 20 wt % or more, preferably from 25 wt % to 45 wt %, wherein the fixed carbon content is determined according to DIN EN 51734; (iii) the ash content of the solid biomass fuel is less than 20 wt %, preferably less than 18 wt %, wherein the ash content is determined according to EN 14775 at 550° C.; (iv) the volatile matter content of the solid biomass fuel is from 35 wt % to 80 wt %, more preferably from 40 wt % to 75 wt %, wherein the volatile matter content is determined according to DIN EN 15148; and/or (v) the internal moisture content of the solid biomass fuel is less than 8 wt %, preferably less than 6 wt %, and more preferably less than 5 wt %, wherein the internal moisture content is determined according to DIN EN 14774.

27. A solid biomass fuel according to any preceding claim, wherein the biomass solid fuel has a calorific value of from 4300 kcal/kg to 6750 kcal/kg, wherein the calorific value is determined in accordance with DIN EN 14918.

28. A solid biomass fuel according to any preceding claim, wherein the solid biomass fuel has a base moisture content of less than 10 wt %, preferably less than 8 wt %, and most preferably less than 6 wt %, wherein the base moisture content is determined according to GB/T211-2017.

29. A solid biomass fuel according to any preceding claim, wherein the pH of the solid biomass fuel is from 4 to 10.

30. A solid biomass fuel according to any preceding claim, wherein the coke characteristics of the solid biomass fuel upon combustion is less than or equal to 1.5; and preferably from 0.3 to 1.5, wherein the coke characteristics are determined according to GB/T8727-2008.

31. A solid biomass fuel according to any preceding claim, wherein the solid biomass fuel is waterproof for up to 20 days, preferably up to 30 days, and more preferably up to 40 days.

32. A solid biomass fuel according to any preceding claim, wherein the PM1.0 emissions of the solid biomass fuel upon combustion is less than 175 mg/kg, preferably less than 150 mg/kg.

33. A combustion process comprising the step of combusting a solid biomass fuel in accordance with any preceding claim so as to produce energy.

34. A process according to claim 33, wherein the solid biomass composition fuel is co-fired and combusted alongside a fossil fuel such as coal.

35. A process according to claim 33 or claim 34, wherein the PM1.0 emissions of the process are less than 175 mg/kg, and preferably less than 150 mg/kg.

36. Use of one or more aluminosilicate-containing clays, one or more aluminosilicates, one or more pulverised fuel ashes, or a combination thereof in a solid biomass fuel as an anti-coking additive.

37. Use according to claim 36, wherein the use comprises using the anti-coking additive to reduce or prevent the formation of solid and/or liquid combustible organic material deposits during combustion of the solid biomass fuel.

38. Use according to claim 37, wherein the solid and/or liquid combustible organic material deposits are deposited on surfaces of a combustion chamber used in combustion of the solid biomass fuel, and/or conduits in fluid communication therewith.

39. Use according to claim 37 or claim 38, wherein the use comprises using the anti-coking additive to prevent or reduce secondary combustion of the solid and/or liquid combustible organic material deposits.

40. Use according to any of claims 37 to 39, wherein the solid and/or liquid combustible organic material comprises soot, tar, or a combination thereof.

41. Use according to any one of claims 36 to 40, wherein the solid biomass fuel is derived from one or more sources of biomass; wherein the one or more sources of biomass comprise straw, palm-derived material, nut shells, hemp, bamboo, corn cob, rice husk, fruit shells, residues, seaweed, calliandra calothyrsus, acacia mangium, albizia chinensis, hevea brasiliensis, grass, or any combination thereof.

42. Use according to any one of claims 36 to 41, wherein the solid biomass fuel is as defined in any one or more of claims 2 to 32.

43. A process for producing a solid biomass fuel according to any one of claims 1 to 32, wherein the process comprises the following steps:
(i) providing a biomass composition comprising biomass particles with an average particle diameter (D50) of from 1,000 μm to 75,000 μm;
(ii) pulverising the biomass composition to provide a pulverised biomass powder with an average particle diameter (D50) of from 500 μm to 10,000 μm;
(iii) drying the pulverised biomass powder so as to provide a dried pulverised biomass powder;
(iv) molding the dried pulverised biomass powder so as to provide a molded biomass product; wherein the dried pulverised biomass powder is molded with one or more aluminosilicate-containing clays, one or more aluminosilicates, pulverised fuel ash, or a combination thereof so as to provide the molded biomass product;
(v) heating the molded biomass product to a temperature of from 110° C. to 500° C. for a time period of from 0.2 to 6 hours so as to provide a solid biomass fuel; and
(vi) removing dust particles from the solid biomass fuel.

44. A process according to claim 43, wherein the biomass composition comprises one or more sources of biomass comprising straw, palm-derived material, nut shells, hemp, bamboo, corn cob, rice husk, fruit shells, crop residues, seaweed, calliandra calothyrsus, acacia mangium, albizia chinensis, hevea brasiliensis, grass, or any combination thereof; optionally, wherein the one or more sources of biomass are as defined in any of claims 2 to 11.

45. A process according to claim 43 or claim 44, wherein the solid biomass fuel, the one or more aluminosilicate-containing clays, one or more aluminosilicates and/or pulverised fuel ash are as defined in any one or more of claims 2 to 32.

46. A process according to any one of claims 43 to 45, wherein adapting the molding step such that the density of the molded biomass product is controlled comprises controlling the compression ratio of a mold used in said molding step.

47. A process according to any one of claims 43 to 46, wherein step (iv) of molding the dried pulverised biomass powder so as to provide a molded biomass product comprises molding the dried pulverised biomass powder with a compression mold with a compression ratio of less than 6; and preferably less than 5.

48. A process according to any one of claims 43 to 47, wherein step (iv) of molding the dried pulverised biomass powder so as to provide a molded biomass product comprises molding the pulverised biomass powder with a compression mold with a compression ratio of less than or equal to 3.5; preferably less than or equal to 3; and more preferably from 1 to 3.

49. A process according to any of claims 43 to 48, wherein the one or more aluminosilicate-containing clays, one or more aluminosilicates, one or more pulverised fuel ashes, or a combination thereof and dried pulverised biomass powder are molded together in a mass ratio so as to provide a solid biomass fuel comprising a total amount of the one or more aluminosilicate-containing clays, one or more aluminosilicates, one or more pulverised fuel ashes, or a combination thereof of from 0.1% to 10% by weight of the solid biomass fuel; preferably from 0.1% to 5% by weight of the solid biomass fuel; more preferably from 0.1% to 1% by weight of the solid biomass fuel; and most preferably from 0.1% to 0.8% by weight of the solid biomass fuel.

50. A process according to any of claims 44 to 49, wherein the one or more aluminosilicate-containing clays, one or more aluminosilicates, one or more pulverised fuel ashes, or a combination thereof and dried pulverised biomass powder are molded together in a mass ratio so as to provide a solid biomass fuel comprising a total amount of the one or more aluminosilicate-containing clays, one or more aluminosilicates, one or more pulverised fuel ashes, or a combination thereof of from 0.5% to 0.8% by weight of the solid biomass fuel.

51. A process according to claim 50, wherein the one or more aluminosilicate-containing clays, one or more aluminosilicates, one or more pulverised fuel ashes, or a combination thereof and dried pulverised biomass powder are molded together in a mass ratio so as to provide a solid biomass fuel comprising the one or more aluminosilicate-containing clays in an amount of from 0.3% to 0.5% by weight of the solid biomass fuel; the one or more aluminosilicates in a total amount of from 0.1% to 0.2% by weight of the solid biomass fuel; and one or more pulverised fuel ashes in an amount of from 0.1% to 0.2% by weight of the solid biomass fuel.
